(19) United States
(12) Patent Application Publication
(10) Pub. No.: US 2011/0179709 A1
(43) Pub. Date: Jul. 28, 2011

(54) Potted Plant Fluid-Delivery Device And Associated Methods

(75) Inventor: Edmund A. Sinda, Bradenton, FL (US)

(73) Assignee: DEVELOPMENTAL TECHNOLOGIES, LLC, Bradenton, FL (US)

(21) Appl. No.: 12/968,743

(22) Filed: Dec. 15, 2010

Related U.S. Application Data
(60) Provisional application No. 61/297,977, filed on Jan. 25, 2010.

(51) Int. Cl. A01G 9/02; F15D 1/00

(52) U.S. Cl. 47/66.7; 47/81; 137/1

(57) ABSTRACT

A system and method are provided for delivering a fluid to a target potted plant. In an embodiment, the potted plant includes an array thereof positioned in a container; in another embodiment, the potted plant includes at least one plant not contained in a container. In both embodiments the plant is positioned in a pot having an aperture through a bottom surface thereof. The system includes a membrane at least a portion of which is hydrophilic, the membrane having an outer surface that is positionable in communication with the pot aperture. The membrane further has an interior adapted for holding a fluid desired to be delivered to the plant. The membrane interior is connectable to a source of the fluid, preferably under low pressure.

### CROSS-REFERENCE TO RELATED APPLICATION

This application claims priority to provisional patent application Ser. No. 61/297,977, filed Jan. 25, 2010.

### TECHNOLOGICAL FIELD

The technological field generally relates to apparatus and methods for delivering fluids to potted plants.

### BACKGROUND

Potted plants are typically arranged in an array within an open container, referred to as a “flat.” The pots have an aperture in a bottom surface thereof. Water is then delivered to the plants from above via spraying or from below by means of the container or flooding. These delivery systems are both inefficient and wasteful of resources, as excess fluids that are not needed by the plants can be provided, only serving to wet the surrounding growing medium and/or escape from the pot aperture.

Previously a highly efficient irrigation system has been described that comprises a porous membrane operating under low pressure (U.S. Pat. No. 7,198,431, co-owned with the present application, the contents of which are incorporated hereinto by reference). This disclosure is directed to a system and method for efficiently delivering an aqueous solution to plants that includes a hydrophilic delivery device, for example, tubing, that has a distal portion positionable adjacent a root system of a plant and a lumen for channeling an aqueous solution from an inlet to the distal portion. At least a portion of the device's wall along the distal portion has a porosity adapted for permitting a flow of the aqueous solution therethrough when acted upon by a surfactant root exudate and/or negative pressure generated by the roots due to water stress. The system further comprises a reservoir that is adapted for holding the aqueous solution therein and is situated in fluid communication with the hydrophilic device's inlet.

It would be desirable to provide a similarly highly efficient system and method for providing fluid to potted plants.

### SUMMARY

A system and method are provided for delivering a fluid to a target potted plant. In an embodiment, the potted plant comprises an array thereof positioned in a container; in another embodiment, the potted plant comprises at least one plant not contained in a container. In both embodiments the plant is positioned in a pot having an aperture through a bottom surface thereof.

The system comprises a membrane at least a portion of which is hydrophilic, the membrane having an outer surface that is positionable in communication with the pot aperture. The membrane further has an interior adapted for holding a fluid desired to be delivered to the plant. The membrane interior is connectable to a source of the fluid, preferably under low pressure.

### BRIEF DESCRIPTION OF THE DRAWINGS

FIG. 1 is a vertical cross-sectional view of a system for delivering a fluid to a plant.

FIG. 2 is a top/side perspective view of a first embodiment of a fluid delivery system for potted plants, in this embodiment.

FIG. 3 is a side perspective and partially cut-away view of two potted plants resting on the fluid delivery system of FIG. 2.

FIG. 4 is a top/side perspective view of a second embodiment of a fluid delivery system for potted plants, in this embodiment for potted plants positioned within a container.

FIG. 5 is a top/side perspective view of a container of potted plants positioned atop the fluid delivery system of FIG. 4.

FIG. 6 is a side view of a pot atop a tube in the fluid delivery system of FIG. 4.

### DETAILED DESCRIPTION OF PREFERRED EMBODIMENTS

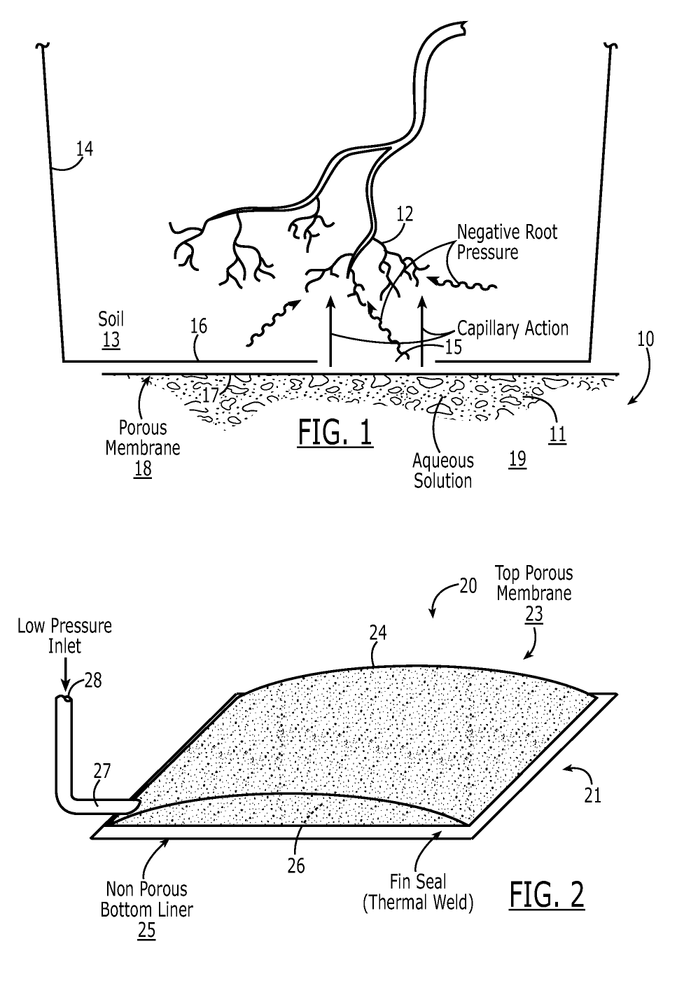

A system and method for fluid delivery to a potted plant will now be presented with reference to FIGS. 1-6.

As used herein, the words “tubes” or “tubing” refer to supply lines for providing fluids to a target plant array. As will be appreciated by one of skill in the art, such “tubes” or “tubing” do not necessarily need to be cylindrical, but may be of any suitable shape, and no limitation is intended by the use of these words.

Generally, the systems 10,20,40 and methods of the present invention supply a fluid 11 to the roots 12 of a plant growing in growth media or soil 13 positioned within a pot 14 having an aperture 15 in a bottom surface 16 thereof. The fluid 11, which can comprise water and/or nutrients and other additives, is released to the plants as needed by the individual plants (FIG. 1). Although not intended as a limitation on the invention, it is believed that when approaching water stress, plant roots emit exudates or surfactants that promote the release of water in addition to negative root pressure. Specifically, the plants are positionable in contact with an outer surface 17 of a membrane 18 and are supplied fluid 11 from an interior 19 of the membrane 18, at least a portion of which is hydrophilic, via capillary action, negative root pressure and osmosis allowing the plant to pull the fluid 11 from the soil 13, also assisting in the capillary action.

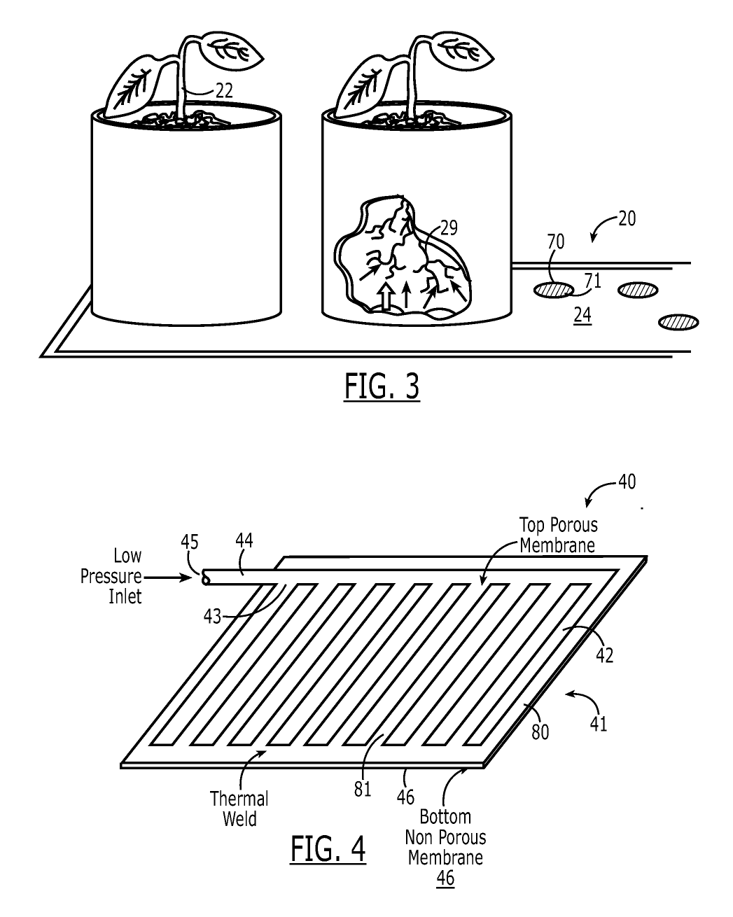

In some embodiments, the membrane may include a plurality of holes 70 (FIG. 3) that are covered by hydrophilic membranes 71; in other embodiments, substantially the entire membrane is hydrophilic.

In particular embodiments, the membrane interior is connected to at least one reservoir that contains water, nutrients, biocides, or a mixture or other substance desired to be delivered to the target plants. As discussed above, it has previously been shown that the plants are capable of distinguishing between these fluids.

Thin-walled microporous hydrophilic tubes are not known to be commercially available for use as irrigation tubing. In a particular embodiment, hydrophilic materials, including Cell-Force™ and Flexi-Sil™, may be made into hydrophilic membranes. Alternatively, some existing hydrophobic thin-walled tubes can be made hydrophilic by a process that uses a water-insoluble hydrophilic polymer (e.g., polyhydroxystyrene, U.S. Pat. No. 6,045,869, co-owned with the present application and incorporated herein by reference). Such solutions applied to microporous hydrophobic plastic tubing have been shown not to clog the pores and to remain hydrophilic for many years. Thus continuous tubes of spunbonded polyolefin (e.g., DuPont's Tyvek microporous polyethylene) having a radius of 5-10 mm have been used after being made hydrophilic and have been shown to act as a membrane that is responsive to the roots of plants in a subsurface irrigation system.

Spunbonded polyolefin in tube form has been used for irrigation purposes. However, the hydrophobic nature of the polyolefin material permits it to act as a drip source of water for plants without any control by the exudates of the plant roots. The conversion of a hydrophobic surface to hydrophilic has been described in the aforementioned '869 patent and can be used to make spunbonded polyolefin tubing hydrophilic and responsive to the water and/or nutrient needs of the plant.

In a first embodiment (FIGS. 2 and 3) a system 20 comprises a “pillow” structure 21 upon which one or more potted plants 22 can be positioned. The membrane 23 in this embodiment 20 comprises at least a portion of a top surface 24 of the pillow structure 21.

The pillow structure 21 has a water-impervious bottom surface 25. An interior 26 defined by the top 24 and the bottom 25 surfaces is adapted for receiving fluid from a tube 27 having an inlet 28 for receiving fluid at low pressure. As can be seen in FIG. 3, roots 29 of the plants 22 draw fluid from the membrane 23 as needed.

In a second embodiment (FIGS. 4-7) a system 40 comprises a grid 41 of tubes 42, at least a portion of which is hydrophilic, connected adjacent proximal ends 43 to a supply line 44 having an inlet 45 connectable to a low-pressure source of fluid, or a high-pressure source of fluid if the plants are desired to receive the fluid irrespective of root exudate. In a particular embodiment, the grid 41 can comprise a base 46 comprising a water-impervious membrane to which are thermally welded the tubes 42,44, although this is not intended as a limitation.

Alternatively, the grid 41 could comprise a unitary structure wherein the tubes 43 are defined by a welding pattern. In this embodiment, the grid 41 can comprise a substantially water-impervious bottom surface 46 and at least partially hydrophilic top surface 80. The tubes 43 can be formed by joining the top 80 and the bottom 46 surfaces at joined areas 81 at spaced-apart intervals to form the tubes 43 between the joined areas 81.

The tubes 42 can have unitary lumina 47 for delivering fluid; alternatively, the tubes 42 can have multi-chambered lumina 47a, 47b (FIG. 7) for delivering a plurality of fluids to the target plants.

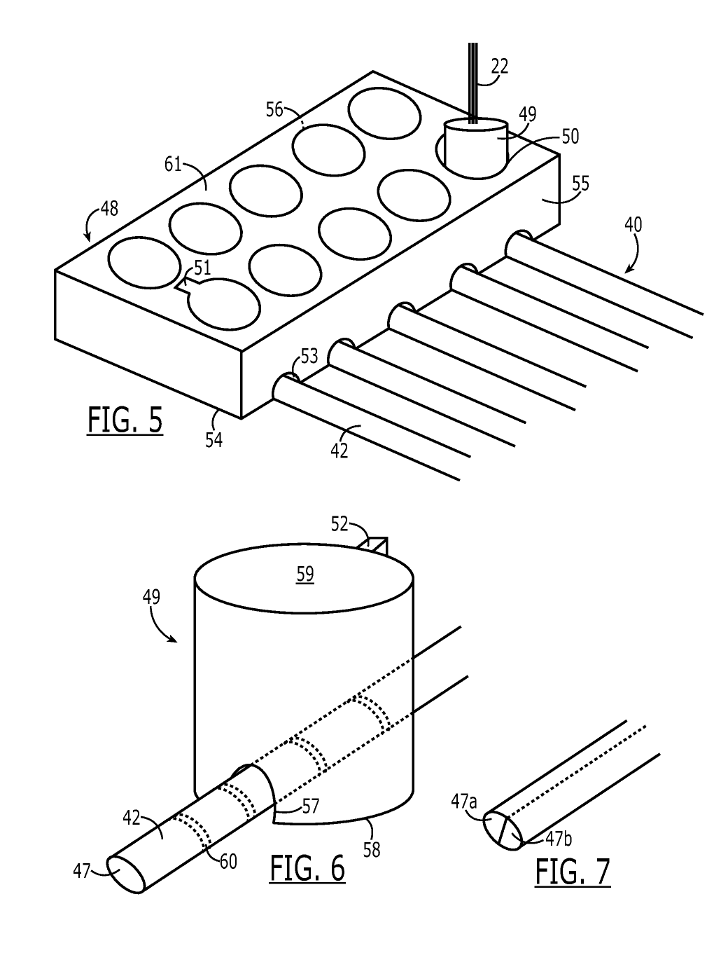

A container 48 (FIG. 5) is adapted for holding a plurality of plant holders such as pots 49 therein. In a particular embodiment, the container 48 can have a plurality of support structures, such as wells 50 in a top surface 61 adapted for supporting the pots 49. Also in a particular embodiment, the container 48 can comprise means for registering the pots 49, such as a keyway 51 for receiving a protrusion 52 extending outwardly from the pot 49. One of skill in the art will appreciate that other means of supporting the pots 49 can be envisioned, such as, but not intended to be limited to, upwardly extending, spring-loaded arms, or other means of supporting the pots 49 in a substantially upright orientation.

The container 48 further has a plurality of substantially parallel grooves 53 extending along a bottom surface 54 thereof from a first side 55 through to a second side 56. The grooves 53 are dimensioned and positioned for alignment with a portion of the tube grid 41 (FIG. 5). The pots 49 further have a diametric groove 57 extending along a bottom surface 58 thereof and into a side wall 59 of the pots 49 (FIG. 6), the groove 57 dimensioned for admitting a tube 42 thereinto.

In use, then, a container 48 of pots 49 is positioned atop the tube grid 41, each pot 49 preferably positioned with its groove 57 atop a tube 42. Roots are then positioned to receive fluid from the tube 42 as needed. The tubes 42 can comprise hydrophilic tubing as discussed above, or alternatively can comprise other tubes known in the art having pores therein. The tubes 42 can also comprise means for enhancing a robustness thereof, for example, semi-circumferential ribs 60 or a stiffening coil.

The present systems and methods have a multiplicity of benefits. First, fluid is delivered in a highly efficient manner, thereby saving water, fertilizer, and any other element desired to be delivered. Evaporative loss is minimized, since the fluid is not exposed to the air as in prior art systems. The potted plants 22 and containers 48 can be placed substantially in any location without concern for fluid source position, an improvement over known sprinkler systems. The systems 10,20,40 promote downward root growth, which improves plant stability, and the roots do not penetrate the membrane surface. Additionally, the systems 10,20,40 are reusable any number of times, thereby conserving materials.

What is claimed is:

1. A system for delivering an aqueous fluid to a plant positioned in a pot having an aperture through a bottom thereof comprising a membrane having a hydrophilic portion positionable in communication with the pot aperture, the membrane defining an interior portion adapted for holding an aqueous fluid therewithin, the interior portion connectable in fluid communication with a source of the aqueous fluid.

2. The system recited in claim 1, wherein the membrane comprises a sheet having a plurality of holes therethrough in a top surface thereof, the holes covered by a hydrophilic membrane and thereby forming the hydrophilic portion.

3. The system recited in claim 1, wherein the membrane comprises a top surface that is substantially completely hydrophilic, the top surface thereby forming the hydrophilic portion, the top surface further flexible for permitting a pot to rest thereupon, the aperture thereby in contact with the top surface.

4. The system recited in claim 3, wherein the membrane further comprises a bottom surface that is substantially fluid-impervious.

5. A method for delivering an aqueous fluid to a plant positioned in a pot having an aperture through a bottom thereof comprising:
positioning a hydrophilic portion of a membrane in communication with the pot aperture, the membrane defining an interior portion adapted for holding an aqueous fluid therewithin;
connecting the membrane interior portion with a source of the aqueous fluid; and
permitting roots of the plant to acquire the aqueous fluid from the membrane.

6. The method recited in claim 5, wherein the membrane comprises a sheet having a plurality of holes therethrough in a top surface thereof, the holes covered by a hydrophilic membrane and thereby forming the hydrophilic portion, and the positioning comprises positioning the pot aperture atop at least one of the holes.

7. The method recited in claim 5, wherein the membrane comprises a top surface that is substantially completely hydrophilic, the top surface thereby forming the hydrophilic portion, the top surface further flexible for permitting the pot to rest thereupon, the aperture thereby in contact with the top surface.

8. The method recited in claim 7, wherein the membrane further comprises a bottom surface that is substantially fluid-impervious.

9. A system for delivering an aqueous fluid to a plant comprising:
a grid comprising a plurality of spaced-apart tubes, each tube having a hydrophilic portion adapted for delivering an aqueous solution through the hydrophilic portion from a lumen thereof, the lumen connectable with a source of the aqueous fluid;
a plurality of pots, each pot having an aperture through a bottom surface thereof; and
means for registering each pot aperture with a tube hydrophilic portion, for permitting delivery of the aqueous fluid to a plant root system contained in the pot.

10. The system recited in claim 9, wherein the grid comprises a substantially water-impervious base having the tubes affixed thereatop.

11. The system recited in claim 9, wherein the grid comprises a substantially water-impervious bottom surface and at least partially hydrophilic top surface, and the tubes are formed by joining the top and the bottom surface at joined areas at spaced-apart intervals to form the tubes between the joined areas.

12. The system recited in claim 9, wherein each pot aperture comprises a groove in a bottom surface of the pot and extending upwardly into a side wall of the pot, the groove dimensioned for admitting a tube thereinto, for permitting a pot to rest atop a tube.

13. The system recited in claim 12, wherein the tubes further comprise means for stiffening the tube lumina for enhancing a robustness thereof.

14. The system recited in claim 13, wherein the stiffening means comprises at least one of a plurality of spaced-apart ribs extending at least partially around a tube circumference and a coil extending along at least a portion of a tube circumference.

15. The system recited in claim 12, further comprising means for supporting a plurality of pots atop the grid.

16. The system recited in claim 15, wherein the supporting means comprises a container having a plurality of wells in a top surface thereof, each well adapted for holding a pot therein, the container further having an opening at a bottom surface positioned for alignment with at least a portion of the grid and for permitting fluid communication between the tubes and the pot grooves.

17. The system recited in claim 16, wherein the container has a plurality of grooves in a bottom surface thereof, the grooves extending upwardly into a side wall of the container, each groove dimensioned for admitting a tube thereinto, for permitting the container to rest atop the grid.

18. The system recited in claim 12, wherein at least some of the tubes have a plurality of lumina therein, for permitting a delivery of different fluids therethrough.

19. A method for delivering an aqueous fluid to a plant comprising:
registering an aperture through a bottom surface of a plurality of pots with a hydrophilic portion at least one of a plurality of tubes forming a grid of spaced-apart tubes, the hydrophilic portion adapted for delivering an aqueous solution therethrough from a lumen thereof; and
connecting the lumen with a source of the aqueous fluid, for permitting delivery of the aqueous fluid to a plant root system contained in the pots.

20. The method recited in claim 19, wherein the grid comprises a substantially water-impervious base having the tubes affixed thereatop.

21. The method recited in claim 19, wherein the grid comprises a substantially water-impervious bottom surface and at least partially hydrophilic top surface, and the tubes are formed by joining the top and the bottom surface at joined areas at spaced-apart intervals to form the tubes between the joined areas.

22. The method recited in claim 19, wherein each pot aperture comprises a groove in a bottom surface of the pot and extending upwardly into a side wall of the pot, the groove dimensioned for admitting a tube thereinto, and the registering comprises permitting a pot to rest atop a tube.

23. The method recited in claim 22, wherein the tubes further comprise means for stiffening the tube lumina for enhancing a robustness thereof.

24. The method recited in claim 23, wherein the stiffening means comprises at least one of a plurality of spaced-apart ribs extending at least partially around a tube circumference and a coil extending along at least a portion of a tube circumference.

25. The method recited in claim 22, further comprising supporting the plurality of pots atop the grid.

26. The method recited in claim 25, wherein:
the supporting comprises placing each pot in a well in a top surface of a container; and
the registering comprises aligning at least a portion of the grid with an opening at a bottom surface of the container, the opening positioned for alignment with at least a portion of the grid and for permitting fluid communication between the tubes and the pot grooves.

27. The method recited in claim 26, wherein the container has a plurality of grooves in a bottom surface thereof, the grooves extending upwardly into a side wall of the container, each groove dimensioned for admitting a tube thereinto, and the registering further comprises permitting the container to rest atop the grid.

28. The method recited in claim 22, wherein at least some of the tubes have a plurality of lumina therein, for permitting a delivery of different fluids therethrough.
